(19) United States
(12) Patent Application Publication
(10) Pub. No.: US 2013/0181433 A1
(43) Pub. Date: Jul. 18, 2013

(54) CHECK PAD FOLIO

(71) Applicants: Charles B. Hadlock, New Braunfels, TX (US); Andres Carrillo, New Braunfels, TX (US)

(72) Inventors: Charles B. Hadlock, New Braunfels, TX (US); Andres Carrillo, New Braunfels, TX (US)

(73) Assignee: HARLAND CLARKE CORP., San Antonio, TX (US)

(21) Appl. No.: 13/620,649

(22) Filed: Sep. 14, 2012

Related U.S. Application Data
(60) Provisional application No. 61/535,658, filed on Sep. 16, 2011.

(51) Int. Cl. B42D 12/00

(52) U.S. Cl. CPC B42D 12/00
USPC 283/58

(57) ABSTRACT

Technologies relating to a product packaging and storage system that is designed to assemble, hold, secure, ship, organize, use and/or store personalized check books and related materials that are used in conjunction with a banking account by consumers and/or businesses and purchased through financial institutions, retailers, and/or directly from a manufacturer of the check books.

### CROSS REFERENCE TO RELATED APPLICATIONS

This disclosure claims the benefit of the priority of U.S. Provisional Application Ser. No. 61/535,658, filed Sep. 16, 2011, and entitled “CHECK PAD FOLIO”, which is hereby incorporated by reference in its entirety.

### BACKGROUND

Checks issued by financial institutions can be stored in a checkbook cover that is designed to hold a single book of checks. The checks can fit inside of the checkbook, and a user of the checkbook can write individual checks out of the opened checkbook cover. An exterior side of the checkbook cover can have various types of designs and patterns.

### SUMMARY

This specification describes technologies relating to a product packaging and storage system, which is referred to herein as a folio, that is designed to assemble, hold, secure, ship, organize, use and/or store personalized check books and related materials that are used in conjunction with a banking account by consumers and/or businesses and purchased through financial institutions, retailers, and/or directly from a manufacturer of the check books.

In an implementation, a check folio comprises a flat sheet of material configured to secure a plurality of pads of checks, wherein the flat sheet of material has an interior side and an exterior side and is configured such that the pads of checks are arranged in a matrix pattern on a common plane along the interior side of the flat sheet of material and an adhesive configured to adhere the pads of checks to the flat sheet of material, wherein the adhesive strength is such each of the check pads are removable by a human from the flat sheet of material, and wherein the flat sheet of material further comprises at least one seam that is configured to allow the flat sheet to fold along the at least one seam such that, when the flat sheet of material is folded, each of the check pads is enclosed within the interior side of the flat sheet of material to form a book-like form factor.

This and other implementations can each optionally include one or more of the following features. The check folio can be configured to have at least two pads of checks to form a stack within the interior side when the flat sheet of material is folded. The check folio can be configured to facilitate being standed vertically when the flat sheet of material is folded. The flat sheet of material can be configured to have at least one of a message and a label for the check pads. The check folio can include a shipping wrapper and a protective sleeve. The matrix pattern can comprise an arrangement where the pads of checks are arranged in rows and columns on the flat sheet of material.

In another implementation, a foldable check pad folio comprises a jacket with an exterior side, an interior side, and a spine to divide the interior side into two sides for folding the jacket of the check folio inwards so that the two sides contact one another, wherein the spine is configured to permit the jacket of the check folio to fold into a book form and a plurality of compartments located on the interior side of the jacket that are configured to hold financial-related items, wherein at least two of the compartments are configured to each hold a check pad.

This and other implementations can each optionally include one or more of the following features. The financial-related items can comprise check pads, check registers, plastic cards for at least one of an automated teller machine (ATM), a debit, a credit, and a gift. The financial-related items can comprise pads of deposit tickets, coupon booklets, forms for facilitating transactions and forms for setting up direct deposits and direct bill pay.

The folio can include an integrated shipping wrapper, wherein the integrated shipping wrapper is configured to be opened on one end and to be used as a protective sleeve for the folio. Each compartment can be associated with a printed indicator that relates to a financial institution or a customer of the financial institution. One or more of the compartments can include an adhesive that permits the compartment to secure the check pad at least until a consumer removes the check pad by pulling the check pad away from the interior of the jacket. The at least two of the compartments configured to each hold the check pad can be located on a common side of one of the two sides of the interior side of the jacket. At least a first side of the interior side of the jacket is configured to hold at least three detachable check pads, and a second side of the interior side of the jacket is configured to hold at least three other detachable check pads. One or more of the compartments can include a slit that permits the compartment to secure a check pad at least until a consumer removes the check pad by pulling the check pad away from the interior of the jacket. A cardstock portion of the check pad can be fed through the slit to secure the check pad to the compartment. In another implementation, a method of manufacturing comprises applying an adhesive to a plurality of locations on one side of a substantially flat substrate, adhering a plurality of check pads to the plurality of locations on the substrate by applying one of the plurality of check pads to each of the locations on the substantially flat adhesive to which adhesive was applied, wherein the plurality of pads of checks are arranged in a matrix pattern of rows and columns, and folding the substrate to form a book-like form factor such that the folded substrate forms an interior side and an exterior side, and interior side of the folded substrate encompasses the plurality of check pads.

This and other implementations can each optionally include one or more of the following features. The method of manufacturing can comprise placing the folded substrate into a flat shipping package and sealing the flat shipping package. The substrate can be comprised of at least one of cardboard or paper. Each of the pads of checks can be physically separated from other pads of checks by a spacial gap. The adhesive can be configured such that the pads of checks are removable from the substrate. The method of manufacturing can comprise, after applying the plurality of pads of checks to the substrate, allowing the adhesive to cure such that the pads of checks are attached to the substrate. Each check in each pad of checks can comprise a check number printed on the check. Applying the plurality of pads of checks to the substrate can comprise applying the pads of checks on the substrate in a sequential number arrangement according to check numbers printed on the checks in the pads of checks. The method of manufacturing can further comprise printing an advertisement on the substrate prior to applying the adhesive to the substrate. The method of manufacturing can further comprise, prior to placing the folded substrate into the flat shipping package, inserting a document of printed instructions within at least the interior side of the folded substrate, wherein the document of printed instructions can comprise instructions for a user of the storage system. The method of manufacturing can further comprise, prior to applying the adhesive to the substrate, printing a barcode on the substrate and the flat shipping package, wherein the barcode comprises information to at least match an address between the pads of checks and the flat shipping package. The method of manufacture can further comprise configuring the flat shipping package to be used as a protective sleeve for the storage system. The method of manufacturing can further comprise, prior to placing the folded substrate into the flat shipping package, inserting a financial-related item within at least the interior side of the folded substrate, wherein the financial-related item comprises at least one of a check register, a deposit ticket, a coupon booklet, a form for facilitating a financial transaction, a form for setting up at least one of a direct deposit and direct bill pay, and a plastic card for at least one of an automated teller machine (ATM), a debit, a credit, and a gift.

Details of one or more implementations of the subject matter described in this specification are set forth in the accompanying drawings and the description below. Other features, aspects, and potential advantages will become apparent from the description, the drawings, and the claims.

### BRIEF DESCRIPTION OF THE DRAWINGS

FIG. 1 depicts an example of an open folio.

FIG. 2 depicts an example of a side view and a bottom view of a closed folio.

FIG. 3 depicts examples of storage features for the folio.

FIG. 4 depicts an example of a folio having messages that are revealed by removable check pads.

FIG. 5 depicts an example of a folio with compartments for a welcome booklet and check pads.

FIG. 6 depicts an example of a folio with compartments for a welcome booklet, a card, and check pads.

FIG. 7 depicts an example of a folio with a shipping wrapper that also serves as a protective sleeve.

FIG. 8 depicts an example for a method of manufacturing and shipping the folio.

FIG. 9 depicts an example for a method of manufacturing the folio.

Like reference numbers and designations in the various drawings indicate like elements.

### DETAILED DESCRIPTION

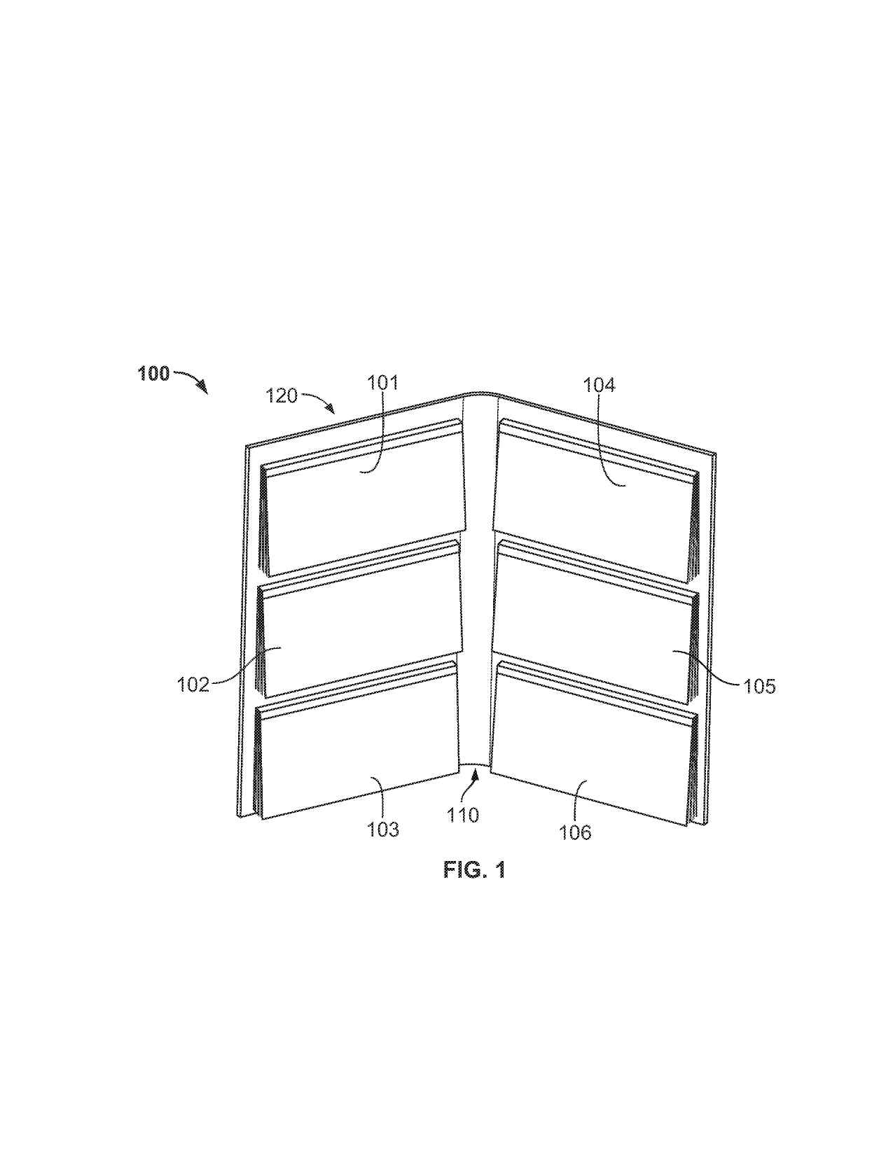

FIG. 1 depicts an example of an open folio 100. The folio 100 can support multiple configurations, including a folio designed to store checks for banking accounts. The folio 100 includes multiple check pads 101, 102, 103, 104, 105, and 106 adhered individually to a folded jacket 120 with a spine 110. In some implementations, check pads 101-106 include personalized blank checks. As shown in FIG. 1, the folio 100 is open to reveal a six-pad configuration, where three pads are separately aligned on the left side of the folio 100 and three pads are separately aligned on the right side of the folio 100. The number of pads in the folio can vary from the number of pads shown in the figures. In some implementations, the pads 101-106 can be adhered to the folio 100 using an adhesive (e.g., a fugitive adhesive, glue, etc.). In some implementations, the pads 101-106 can be attached to the folio 100 using slits, or openings, in the folio. For example, a cardstock backer portion of pads 101-106 can be secured to the folio 100 by being fed through the slit. The use of a cardstock backer and slit to secure the pads 101-106 to the folio 100 may be completed similar to the way check pads are secured to checkbook covers. For example, where there is a plastic sleeve or slit in the checkbook cover in which the check pad backer is fed. In addition, the folio can have multiple different types of configurations, supporting not only a variety of pad counts, but other related (e.g., financial related) products. For example, the folio can be configured to transport, hold, secure, and store one or more check pads, check registers, plastic cards (e.g., ATM, debit, credit, gift cards), pads of deposit tickets, coupon booklets, forms for facilitating transactions (e.g., forms for setting up direct deposits and direct bill pay), and the like.

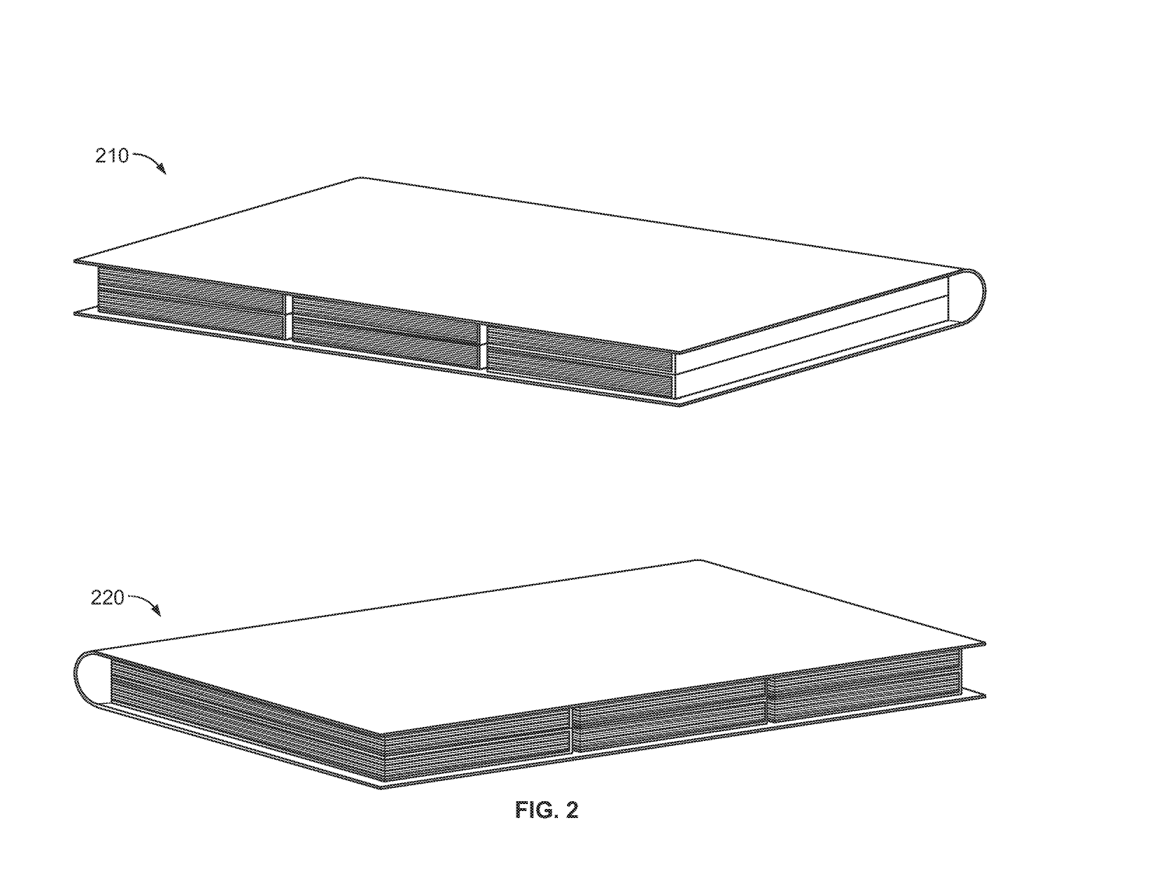

FIG. 2 depicts an example of a side view 210 and a bottom view 220 of a closed folio. The side view 210 shows a side of the six-pad configuration of the closed folio, and the bottom view 220 shows the bottom two pads of the closed folio. When the folio is closed, the folio stacks the left side and right side check pads together to form three stacks of check pads, where each check stack has two check pads (e.g., three stacks, where each stack is two check pads deep). The number of pads in the folio can vary from the number of pads shown in the figures.

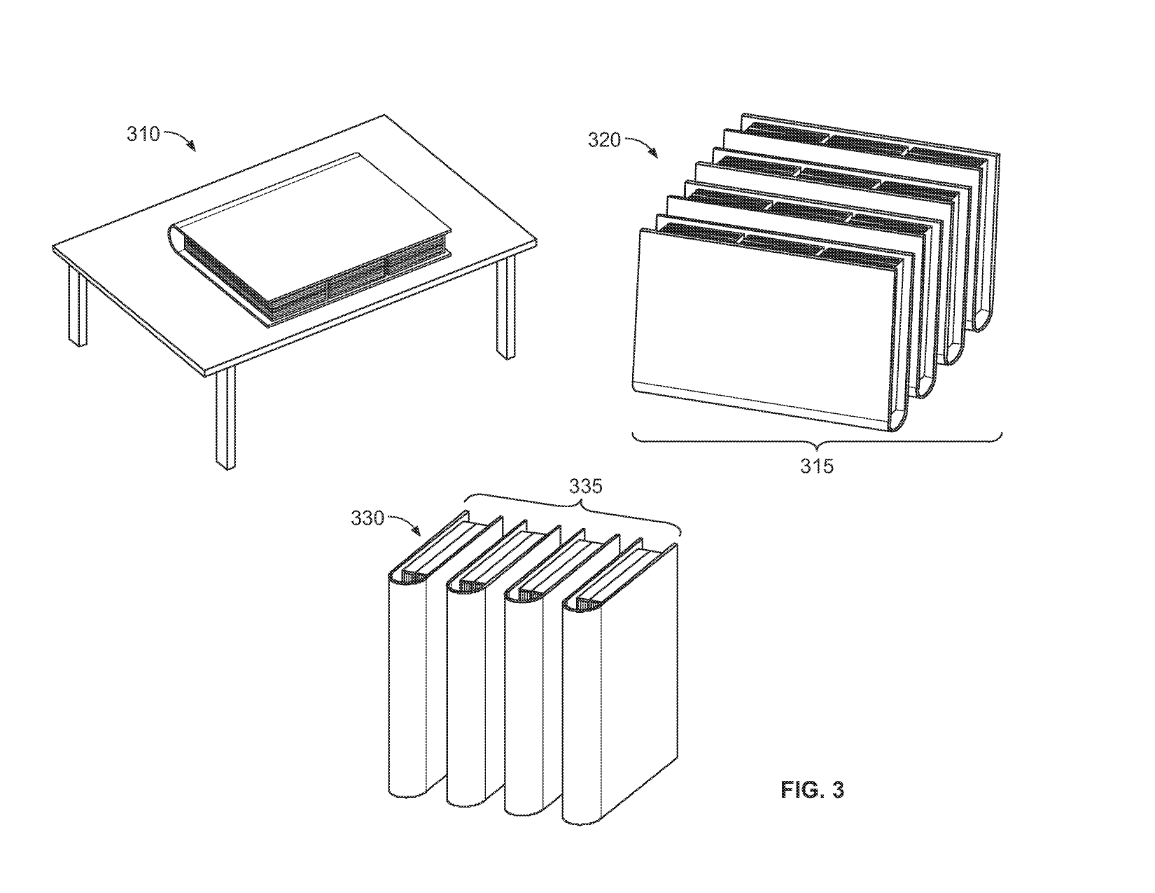

FIG. 3 depicts examples of storage features for the folio. The folio can be opened and closed like a book. For instance, the folio 310 can be closed and laid flat to be placed on a desk or in a drawer. The folio can be configured for lying flat so that checks can be written out of the folio, for example, as for a person writing a check on the folio on their home desk. The folio can be arranged so that personal blank checks, which are sequentially numbered, are clearly presented in order and reinforced with visual indicators, such that the user does not have to verify the pad sequence. The design of the folio can convey a sense of organization for the checks in the folio, especially when the folio is opened and observed the first time. Because the user of the folio can see all pads at one time, the user can immediately see multiple designs (for example, for checks that have multiple scenes) and verify the accuracy of personalization on all of the pads simultaneously.

The closed folio 320 can also be positioned vertically to be placed in a filing cabinet with files or other folios 315. The closed folio 330 can also be stored vertically to be placed on a shelf with books or other folios 335. The folded jacket of the folio can help to disguise the contents of the package, and obfuscate the pad shapes both visually and through touch. The design of the folio obscures the contents of the folio and provides a level of security in shipping and receiving checks and related products.

The folio can be configured to ship and store in the closed position. The folio can be opened repeatedly for visual inspection, and can have a check pad removed for writing checks separately from the folio.

The folio can be designed to carry printed messages and branding on the outside and inside of the folio. The printed messages and branding can be unique to the consumer's financial institution or other check provider. Digital messaging, such as one-to-one messaging (e.g., one message per pad) can also be supported. The digital messaging can refer to a message that is targeted or designed for the consumer that is printed on a portion of an interior of the folio jacket or an exterior of the folio jacket.

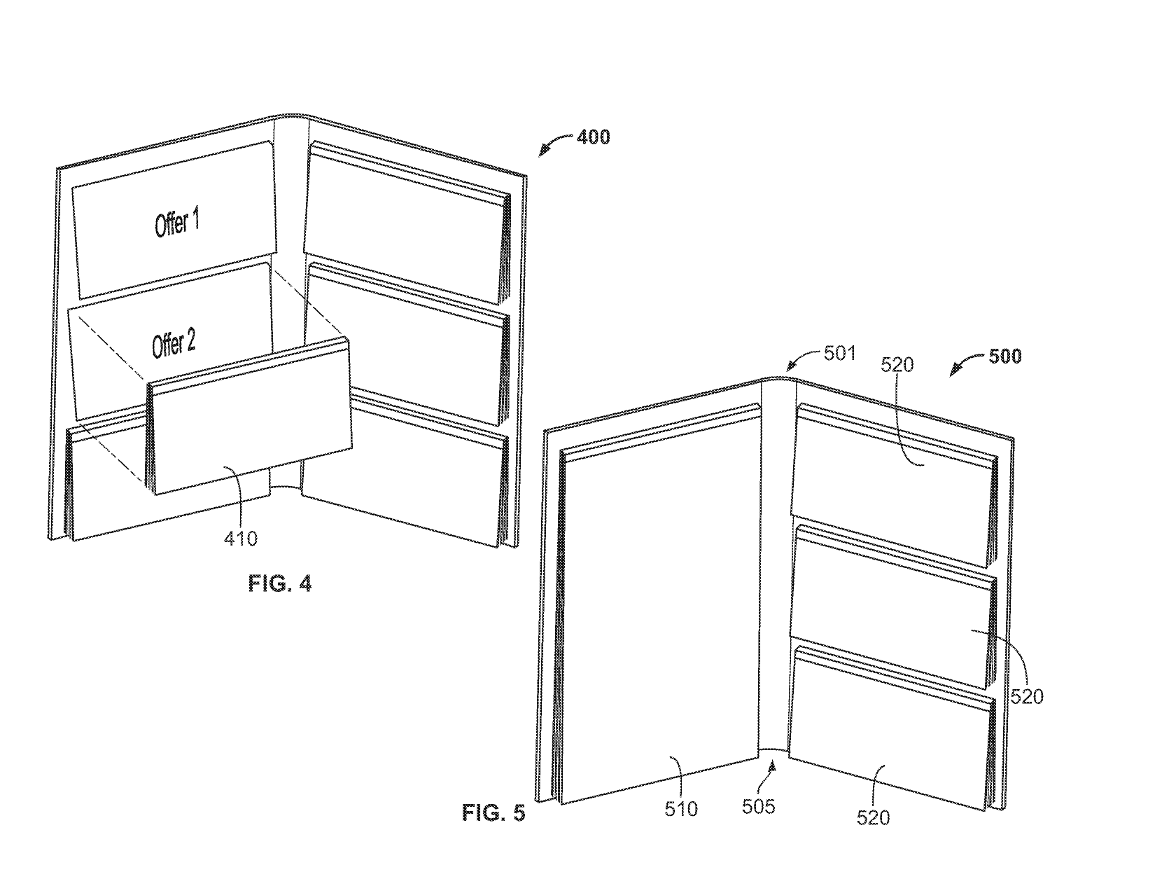

FIG. 4 depicts an example of a folio 400 that has messages revealed by removable check pads. In the six-pad configuration, a message may be applied on an interior of the jacket for a space under each pad, where six separate messages can be revealed as each pad is removed or through discovery by looking under the pad without removing the pad. A pattern of the glue connecting the pad 410 to the folio 400 can designed to allow a user to discover advertisements underneath the pad. The glue can be applied along a top, back edge of each pad so that the consumer can view the printed material underneath the pad when lifting a back of the respective pad off of the folio.

FIG. 5 depicts an example of a folio 500 in a configuration with compartments for a welcome booklet 510 and check pads 520. The welcome booklet 510 is positioned on one side of spine 501 of the interior side of the folio jacket 505, and the check pads 520 are positioned on another side of the spine of the interior side of the folio jacket 505. When the folio jacket 505 is closed along the spine 501, the welcome booklet 510 and check pads 520 are positioned on the interior side of the folio jacket 505 for storage or for transporting to another location.

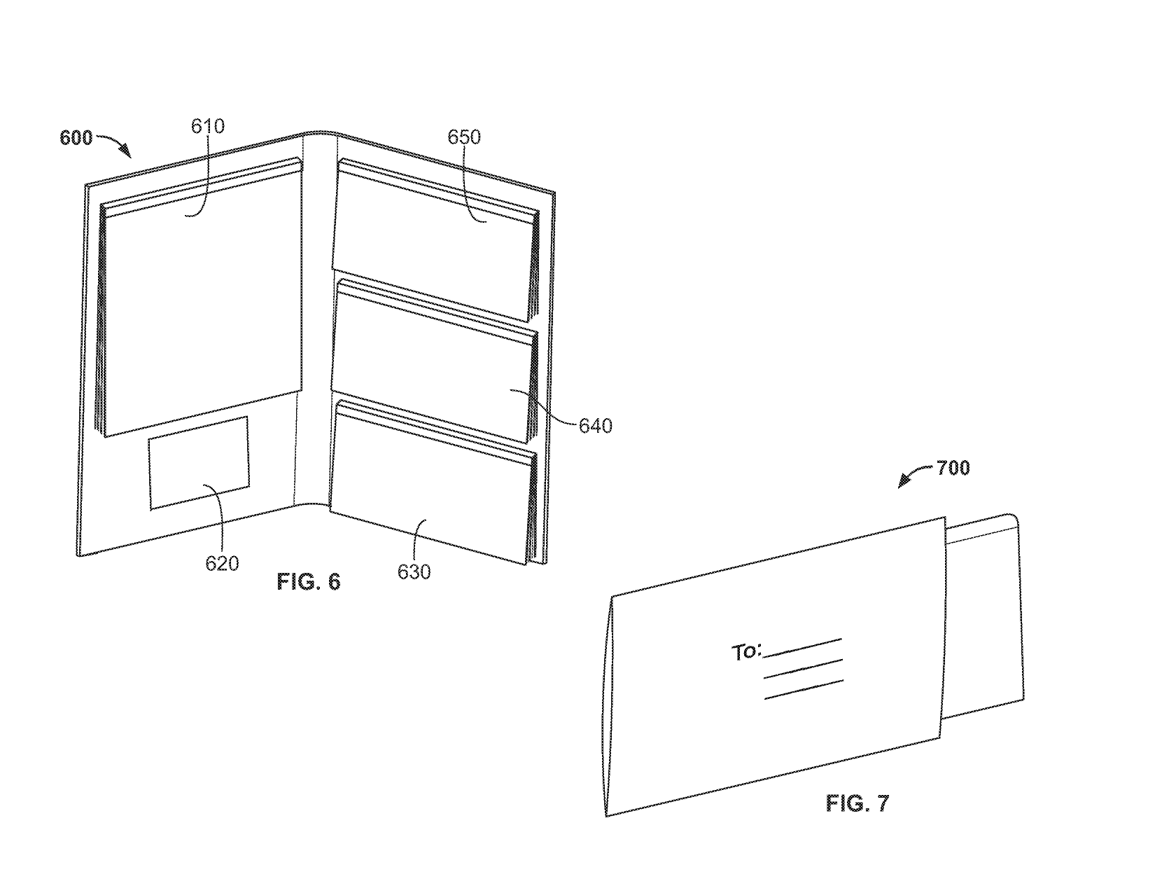

FIG. 6 depicts an example of a folio 600 with compartments for a welcome booklet 610, a card 620 (e.g., an ATM, debit, credit, or gift card), and check pads 630, 640, and 650.

In some implementations, a method of making the pads adhere to the folio can involve keeping the pads in place during shipment and storage, but configuring the pads in the folio such that the pads can be easily removed one at a time. The folio can also be designed so that the pads can be placed back into the folio, for example, after a duplicate pad of checks has been completed.

The folio can have multiple different types of configurations, supporting not only a variety of pad counts, but other related (e.g., financial related) products. As shown in the examples of the folios in FIGS. 5 and 6, the folio can be configured to transport, hold, secure, and store one or more check pads, check registers, plastic cards (e.g., ATM, debit, credit, gift cards), pads of deposit tickets, coupon booklets, forms for facilitating transactions (e.g., forms for setting up direct deposits and direct bill pay), and the like.

FIG. 7 depicts an example of a folio 700 with a shipping wrapper that is also a protective sleeve. The shipping wrapper is part of the folio and is designed to be opened on one end and be reused as a protective sleeve. The folio may have a pop-up storage container for items as well. Alternatively, the folio may have the shipping wrapper instead of the pop-up storage container.

The folio design can work with automated shipping equipment to provide efficiencies in the shipping process. Packaging equipment may be used to assemble items into a folio package.

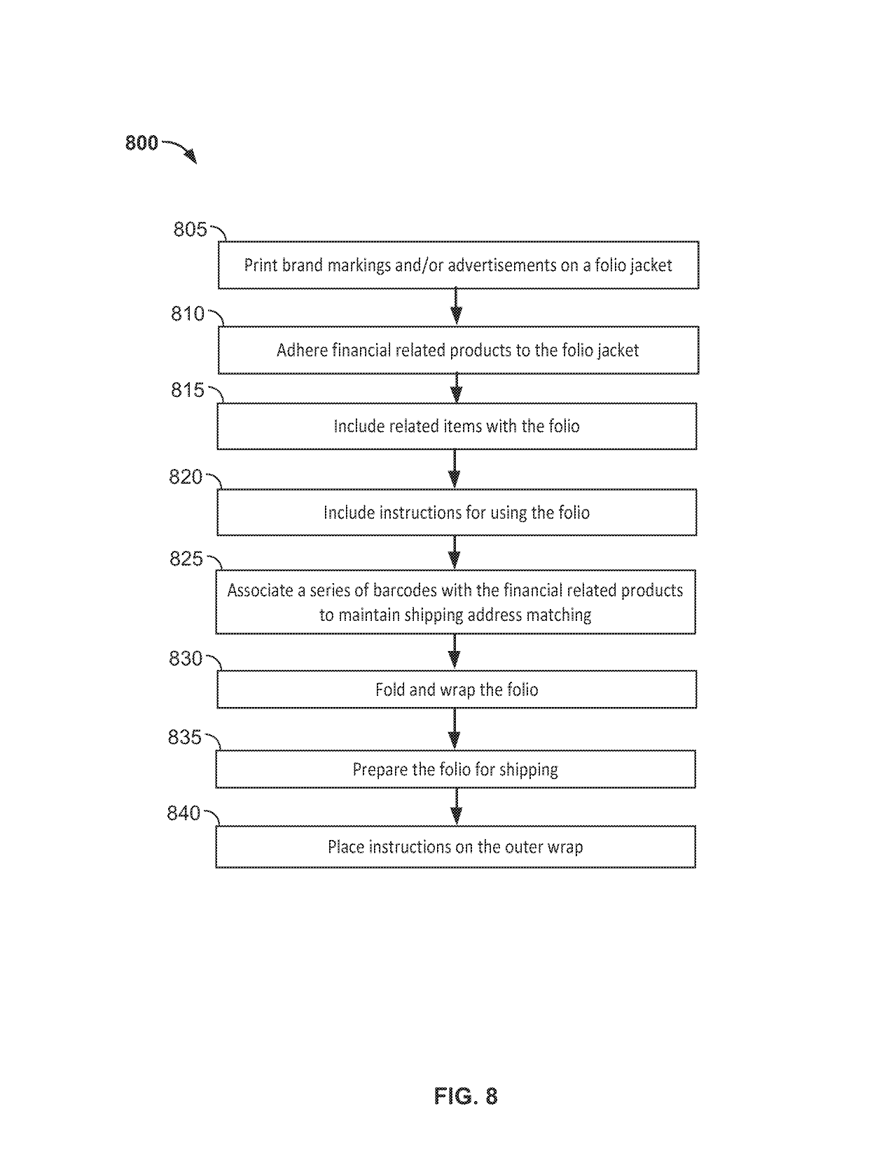

FIG. 8 depicts an example for a method of manufacturing and shipping the folio. At 805, brand markings and/or advertisements can be printed on a folio jacket. In some implementations, the printing is performed via offset or on-demand digital printing. At 810, financial related products (e.g., check pads) can be adhered to the folio jacket. In some implementations, the financial related products are adhered to the folio jacket using glue that holds but also releases the products. In some implementations, a glue pattern may be used that allows for discovery of advertisements on the folio jacket without removing the financial instruments. At 815, related items (e.g., inserts, vinyl cover, register, small catalog) can be dropped in on top of, or alongside, the financial instruments. At 820, instructions can be included to educate a recipient of the uses of the folio design. For example, the instructions may educate the recipient on writing checks in the folio or out of the folio and/or storing the folio in a drawer, in a hanging file, or on a shelf. At 825, a series of barcodes can be associated with the financial related products to maintain shipping address matching. For example, a series of barcodes can be used to maintain check and shipping address matching. At 830, the folio can be folded and wrapped in a manner that supports 840. At 835, the folio can be prepared for shipping in a manner that adheres to rules for carrier flat packages. At 840, instructions can be placed on the outer wrap to indicate to a recipient/customer a method of opening the package such that the outer wrap is a reusable, protective sleeve. In some implementations, the outer wrap may be made of material that can reveal if the folio has been tampered with prior to reaching the recipient/customer.

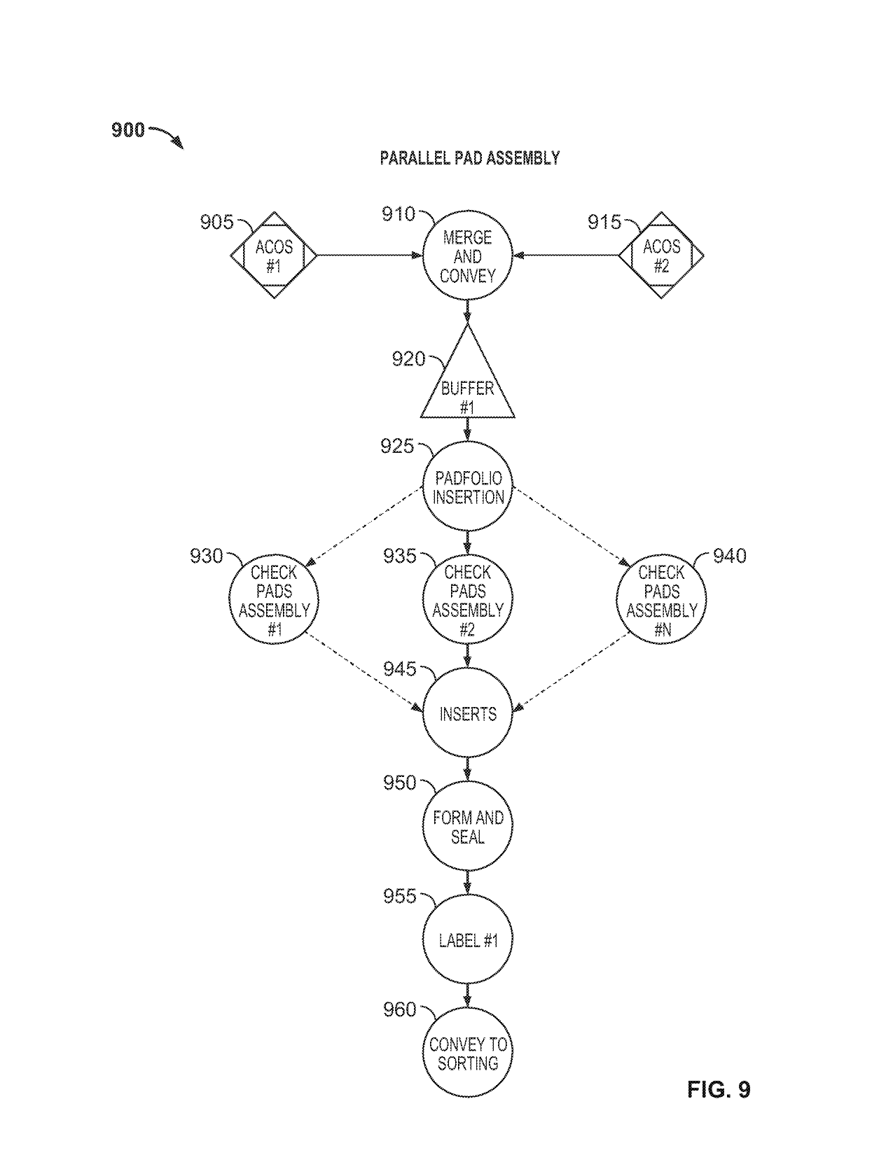

FIG. 9 depicts an example for a method 900 of manufacturing the folio. The method 900 involves performing a parallel pad assembly by merging and conveying acquired check pads 905 and 915 at 910. The merging and conveying of the check pads are buffered at 920 for a time and the pad folio insertion is performed at 925 for multiple check pad assemblies (930, 935, 940) (e.g., check pad assemblies 1 . . . N), and inserts are placed without glue in the folio at 945. The folio is then formed and sealed at 950 and labels can be placed on the folio's outer wrap at 955. Then, the folio can be conveyed and sorted for shipping at 960.

While this specification contains many specifics, these should not be construed as limitations on the scope of what may be claimed, but rather as descriptions of features specific to particular implementations. Certain features that are described in this specification in the context of separate implementations can also be implemented in combination in a single configuration. Conversely, various features that are described in the context of a single configuration can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various components in the implementations described above should not be understood as requiring such separation in all implementations, and it should be understood that the described components and systems can generally be integrated together in a single product or packaged into multiple products.

Thus, other implementations are within the scope of the following example enumerated implementations. For example, the actions recited in the example enumerated implementations can be performed in a different order and still achieve desirable results.

What is claimed is:

1. A check folio comprising:
a flat sheet of material configured to secure a plurality of pads of checks, wherein the flat sheet of material has an interior side and an exterior side and is configured such that the pads of checks are arranged in a matrix pattern on a common plane along the interior side of the flat sheet of material; and
an adhesive configured to adhere the pads of checks to the flat sheet of material, wherein the adhesive strength is such each of the check pads are removable by a human from the flat sheet of material; and
wherein the flat sheet of material further comprises at least one seam that is configured to allow the flat sheet to fold along the at least one seam such that, when the flat sheet of material is folded, each of the check pads is enclosed within the interior side of the flat sheet of material to form a book-like form factor.

2. The check folio of claim 1, wherein the check folio is configured to have at least two pads of checks to form a stack within the interior side when the flat sheet of material is folded.

3. The check folio of claim 1, wherein the check folio is configured to facilitate being standed vertically when the flat sheet of material is folded.

4. The check folio of claim 1, wherein the flat sheet of material is configured to have at least one of a message and a label for the check pads.

5. The check folio of claim 1, wherein the check folio further comprises a shipping wrapper and a protective sleeve.

6. The check folio of claim 1, wherein the matrix pattern comprises an arrangement where the pads of checks are arranged in rows and columns on the flat sheet of material.

7. A foldable check pad folio comprising:
a jacket with an exterior side, an interior side, and a spine to divide the interior side into two sides for folding the jacket of the check folio inwards so that the two sides contact one another, wherein the spine is configured to permit the jacket of the check folio to fold into a book form; and
a plurality of compartments located on the interior side of the jacket that are configured to hold financial-related items, wherein at least two of the compartments are configured to each hold a check pad.

8. The foldable check pad folio of claim 7, wherein the financial-related items comprise check pads, check registers, plastic cards for at least one of an automated teller machine (ATM), a debit, a credit, and a gift.

9. The foldable check pad folio of claim 7, wherein the financial-related items comprise pads of deposit tickets, coupon booklets, forms for facilitating transactions and forms for setting up direct deposits and direct bill pay.

10. The foldable check pad folio of claim 7, wherein the folio further comprises an integrated shipping wrapper, wherein the integrated shipping wrapper is configured to be opened on one end and to be used as a protective sleeve for the folio.

11. The foldable check pad folio of claim 7, wherein each compartment is associated with a printed indicator that relates to a financial institution or a customer of the financial institution.

12. The foldable check pad folio of claim 7, wherein one or more of the compartments include an adhesive that permits the compartment to secure the check pad at least until a consumer removes the check pad by pulling the check pad away from the interior of the jacket.

13. The foldable check pad folio of claim 7, wherein the at least two of the compartments configured to each hold the check pad are located on a common side of one of the two sides of the interior side of the jacket.

14. The foldable check pad folio of claim 13, wherein at least a first side of the interior side of the jacket is configured to hold at least three detachable check pads, and a second side of the interior side of the jacket is configured to hold at least three other detachable check pads.

15. The foldable check pad folio of claim 7, wherein one or more of the compartments include a slit that permits the compartment to secure a check pad at least until a consumer removes the check pad by pulling the check pad away from the interior of the jacket.

16. The foldable check pad folio of claim 15, wherein a cardstock portion of the check pad is fed through the slit to secure the check pad to the compartment.

17. A method of manufacturing comprising:
applying an adhesive to a plurality of locations on one side of a substantially flat substrate;
adhering a plurality of check pads to the plurality of locations on the substrate by applying one of the plurality of check pads to each of the locations on the substantially flat adhesive to which adhesive was applied, wherein the plurality of pads of checks are arranged in a matrix pattern of rows and columns; and
folding the substrate to form a book-like form factor such that the folded substrate forms an interior side and an exterior side, and interior side of the folded substrate encompasses the plurality of check pads.

18. The method of claim 17 further comprising:
placing the folded substrate into a flat shipping package; and
sealing the flat shipping package.

19. The method of claim 17, wherein the substrate is comprised of at least one of cardboard or paper, and wherein each of the pads of checks are physically separated from other pads of checks by a spacial gap.

20. The method of claim 17, wherein the adhesive is configured such that the pads of checks are removable from the substrate.

21. The method of claim 17, further comprising, after applying the plurality of pads of checks to the substrate, allowing the adhesive to cure such that the pads of checks are attached to the substrate.

22. The method of claim 17, wherein each check in each pad of checks comprises a check number printed on the check, wherein applying the plurality of pads of checks to the substrate comprises applying the pads of checks on the substrate in a sequential number arrangement according to the check numbers printed on the checks in the pads of checks.

23. The method of claim 17, further comprising, printing an advertisement on the substrate prior to applying the adhesive to the substrate.

24. The method of claim 17, further comprising, prior to placing the folded substrate into the flat shipping package, inserting a document of printed instructions within at least the interior side of the folded substrate, wherein the document of printed instructions comprise instructions for a user of the storage system.

25. The method of claim 17, further comprising, prior to applying the adhesive to the substrate, printing a barcode on the substrate and the flat shipping package, wherein the barcode comprises information to at least match an address between the pads of checks and the flat shipping package.

26. The method of claim 17, further comprising configuring the flat shipping package to be used as a protective sleeve for the storage system.

27. The method of claim 17, further comprising, prior to placing the folded substrate into the flat shipping package, inserting a financial-related item within at least the interior side of the folded substrate, wherein the financial-related item comprises at least one of a check register, a deposit ticket, a coupon booklet, a form for facilitating a financial transaction, a form for setting up at least one of a direct deposit and direct bill pay, and a plastic card for at least one of an automated teller machine (ATM), a debit, a credit, and a gift.
